(19) United States
(12) Patent Application Publication
(10) Pub. No.: US 2004/0160117 A1
(43) Pub. Date: Aug. 19, 2004

(54) Towed vehicle auxiliary braking apparatus including improved pressure vessel and method of making same

(76) Inventors: Alec D. Brock, Colorado Springs, CO (US); Daniel L. Decker JR., Castle Rock, CO (US); Leland C. Leber, Fort Collins, CO (US); Fredrick L. Stone, Longmont, CO (US); Jeffery T. Samson, Boulder, CO (US)

Correspondence Address: Brent P. Johnson, SHERIDAN ROSS. P.C., Suite 1200, 1560 Broadway, Denver, CO, 80202-5141, US

(21) Appl. No.: 10/739,491

(22) Filed: Dec. 17, 2003

Related U.S. Application Data
(63) Continuation-in-part of application No. 10/295,967, filed on Nov. 15, 2002.

(51) Int. Cl. B60T 13/66

(52) U.S. Cl. 303/20

(57) ABSTRACT

An improved auxiliary braking apparatus adapted for use with a towed vehicle is provided. In order to provide a more accurate device that is substantially unaffected by gravitational changes experienced while in transit, the auxiliary braking apparatus uses a solid state inertia device to sense changes in inertia attributable to the braking of the towing vehicle. The braking apparatus includes a molded reservoir/pressure vessel with integral attaching features. The reservoir may be constructed from a two step injection molding process thereby lowering overall manufacturing costs of the braking apparatus as well as improving the ability of the reservoir to be directly mounted to the housing of the braking apparatus.

### CROSS REFERENCE TO RELATED APPLICATION

This application is a continuation-in-part application of U.S. Ser. No. 10/295,967, filed Nov. 15, 2002, entitled “Towed Vehicle Auxiliary Braking Apparatus”, the disclosure of which is incorporated herein by reference in its entirety.

### FIELD OF THE INVENTION

The present invention relates to a braking apparatus, and more particularly to an improved, stand alone, auxiliary braking apparatus for towed vehicles.

### BACKGROUND OF THE INVENTION

When traveling by motor home, it is often desirable to tow a secondary vehicle behind the motor home. During such trips, the towed vehicle essentially becomes dead weight and pushes the motor home when the operator tries to slow or stop, which can put so much stress on the motor home's brakes that they may fade or completely fail. By braking the towed vehicle in tandem with the motor home, the brakes of the motor home do not have to handle the additional momentum of the towed vehicle, thereby reducing the overall load on the brakes of the motor home and increasing their overall life span.

Various methods of braking the towed vehicle in tandem with the motor home are well known in the art. Self-contained supplemental braking systems are sold which require no permanent installation in the towed vehicle. Rather, such braking systems are positioned on a floorboard of the driver-side of the towed vehicle and utilize air or pneumatic cylinders that depress the brake pedal of the towed vehicle. Typically, these cylinders are activated by variations in inertia sensed by the supplemental braking system due to the braking, and inevitable slowing, of the towing vehicle. As is seen in U.S. Pat. No. 6,126,246 to Decker, Sr. et al. (which is herein incorporated in its entirety), such changes in inertia are detected by a pendulum whisker switch combination that ultimately activates a hydraulic or pneumatic cylinder. The problem with using mechanical devices like pendulums, however, is that such devices are more susceptible to being influenced by gravity when the towed vehicle is traversing up or down a hill (ie., the pendulum is held back or is advanced forward), thereby causing the supplemental braking system to prematurely or tardily activate. Thus, the operator can never know how much braking pressure to apply before the system will activate. Such uncertainty causes the operator to apply differing amounts of braking force to the towing vehicle, which affects the handling of the motor home and impacts the overall life span of the motor home's brakes. Vehicles with sloping floorboards can also create the same effect. Thus, there is a need for an auxiliary braking system that can be reliably used with all types of vehicles, including those with sloped floorboards, and which factors out the effects of gravitational changes resulting from traversing hilly terrain.

Another problem with conventional supplemental braking systems is that they have a limited sensitivity range. In order to adjust the sensitivity for these types of systems, the operator typically manipulates the length of the pendulum arm, which delays or accelerates the arm's path and hence, increases or decreases the amount of time needed to contact the switch which ultimately activates the piston arm used to depress the brake. Thus, the operator is limited by the physical length of the arm as to the number of sensitivity settings. Moreover, the unwanted susceptibility to gravitational changes precludes the operator from confidently setting the sensitivity of the system. For example, if the operator sets the sensitivity of the system to an extremely sensitive setting while both the towing and towed vehicles are on flat surfaces, then when the operator drives down a hill, the supplemental braking system will prematurely activate because the pendulum arm will advance toward and activate the switch. Conversely, when the operator ascends a hill, the supplemental braking system will slightly lag behind the operator's original setting because the pendulum arm is being held back by gravity. Thus, there is a need for a supplemental braking system, which allows the operator to accurately set the sensitivity of the actuation device contained therein regardless of the angle of the terrain.

Still yet another problem with conventional, supplemental braking systems is that such systems are generally difficult to install or remove due to their cumbersome, box-like, outer housings and lack of ergonomic handles, a problem that becomes particularly pronounced for elderly recreational vehicle owners, many of whom may have limited arm strength to maneuver the systems in and out of the vehicle. Moreover, these systems must be secured along the floorboard for proper operation by either mounting the system to the floorboard or using a stand-off device to wedge the system between the brake pedal and the driver's seat. It is not uncommon for an owner to install or remove such a system several times during a trip due to the desire to use the towed vehicle in various locations. Known carrying handles, however, are not ergonomically placed and do not serve any additional function, thereby driving up manufacturing costs and simply take up space. Thus, there is a need to develop a supplemental braking system that has a handle that is more ergonomic and which also serves to secure the system so that manufacturing costs are kept to a minimum.

### SUMMARY OF THE INVENTION

The present invention is designed to overcome the aforementioned problems and meet the aforementioned, and other, needs. It is thus one aspect of the present invention to provide an auxiliary braking apparatus with an inertia detection mechanism for a towed vehicle that can be used in all types of vehicles and which is less susceptible to gravitational pull and hence, more accurate. It is another aspect of the present invention to provide an auxiliary braking apparatus that is not limited in sensitivity settings by the physical attributes of the actuation device, such as a pendulum. A solid state inertia device with a strain gauge in communication with a circuit board activate an air cylinder, which ultimately depresses the brake pedal of the towed vehicle. Changes in inertia are translated into voltage readings (i.e., voltage build-up) that are interpreted by the circuit board, which are then conveyed to a valve that activates a piston arm of the cylinder that is interconnected to the brake pedal. The solid state inertia device is less affected by elevational changes or sloped floor boards than conventional pendulum devices, thereby offering more efficient use of the auxiliary braking system for the towed vehicle. Through the use of additional hardware, such as capacitors, the voltage build-up can be zeroed out every few seconds, thereby negating any voltage accumulated by traversing uneven terrain. Thus, the auxiliary braking apparatus will more accurately respond to changes in inertia due to the braking of the towing vehicle. Still further, by varying the amount of voltage needed to activate the auxiliary braking system, the operator has a greater range of sensitivity settings for the apparatus because he or she is not limited by the physical attributes of a physical device, such as a pendulum.

It is yet another aspect of the present invention to combine the functionality of a more ergonomic handle with a stand-off device to secure the auxiliary braking apparatus against the driver's side floorboard of the towed vehicle while in transit. Thus, an ergonomic, adjustable brace element is interconnected to a housing of the auxiliary braking apparatus. By combining the functionality of the carrying handle with the need for a stand-off device to secure the braking apparatus, manufacturing costs are lowered, and cost and weight savings are achieved.

In yet another aspect of the present invention, an improved pressure vessel or reservoir is provided to include a method of making the same. In the braking apparatus, the reservoir is provided as a means to store pressurized fluid thereby enabling controlled actuation of a cylinder. The reservoir is manufactured by injection molding of a glass filled nylon material. In addition to the actual reservoir itself, other features may be integrally molded with the reservoir to include means to attach the reservoir to the housing of the braking apparatus. Through the molding process, the reservoir may be manufactured at a much lesser cost compared to traditional pressure vessels/reservoirs which are typically made from metal and must undergo a more complex and expensive manufacturing process.

In the preferred embodiment of the braking apparatus of the present invention, it includes a housing, an actuator arm at least partially encased by an inner surface of the housing and having a first rest position and a second use position, a solid state inertia device communicating with the actuator arm, a first member in communication with the actuator arm and capable of contacting a brake pedal of the towed vehicle, and a power supply capable of actuating the actuator arm.

In the first rest position, the actuator arm is in a non-extended state, and in the second use position, the actuator arm is extended to cause the first member to depress the brake pedal of the towed vehicle in response to a communication from the solid state inertia device.

In another aspect of the present invention, the pressure vessel alone may be considered a subcombination as the pressure vessel has utility in multiple other uses. In any mechanical device which requires storage of a pressurized fluid, the pressure vessel of the present invention may be advantageous for use because of its molded construction as well as integrally molded features which allow mounting of the reservoir. Additionally, the method of manufacturing the pressure vessel can be considered as having separate utility as well.

Other features and advantages of the present invention will become apparent by a review of the following drawings taking in conjunction with the detailed description of the invention.

### BRIEF DESCRIPTION OF DRAWINGS

FIG. 1 is a side perspective view of one embodiment of the auxiliary braking apparatus in use with a towed vehicle;

FIG. 2 is a perspective view of one embodiment of the auxiliary braking apparatus;

FIG. 3 is a front elevation view of the auxiliary braking apparatus shown in FIG. 2;

FIG. 4 is a rear elevation view of the auxiliary braking apparatus shown in FIG. 2;

FIG. 5 is a left side elevation view of the auxiliary braking apparatus shown in FIG. 2;

FIG. 6 is a right side perspective view of the auxiliary braking apparatus shown in FIG. 2;

FIG. 7 is a top perspective view of the auxiliary braking apparatus shown in FIG. 2;

FIG. 8 is a bottom perspective view of the auxiliary braking apparatus shown in FIG. 2;

FIG. 9 is a basic schematic representation of one embodiment of the auxiliary braking apparatus;

FIG. 10 is a top perspective view of one embodiment of the upper shell of the auxiliary braking apparatus;

FIG. 11 is a front perspective view of the upper shell shown in FIG. 10;

FIG. 12 is a bottom perspective view of the upper shell shown in FIG. 10;

FIG. 13 is a front elevation view of the upper shell shown in FIG. 10;

FIG. 14 is a left side elevation view of the upper shell shown in FIG. 10;

FIG. 15 is a rear elevation view of the upper shell shown in FIG. 10;

FIG. 16 is a top perspective view of one embodiment of the lower shell of the auxiliary braking apparatus;

FIG. 17 is a front elevation view of the lower shell shown in FIG. 16;

FIG. 18 is a bottom perspective view of the lower shell shown in FIG. 16;

FIG. 19 is a right side perspective view of the lower shell shown in FIG. 16;

FIG. 20 is a rear elevation view of the lower shell shown in FIG. 16;

FIG. 21 is a top perspective view of one embodiment of the stand-off member of the auxiliary braking apparatus;

FIG. 22 is a front elevation view of the stand-off member shown in FIG. 21;

FIG. 23 is a bottom perspective view of the stand-off member shown in FIG. 21;

FIG. 24 is a right side elevation view of the stand-off member shown in FIG. 21;

FIG. 25 is a front perspective view of the stand-off member shown in FIG. 21;

FIG. 26 is a rear elevation view of the stand-off member shown in FIG. 21;

FIG. 27 is a more detailed right side elevation view of the stand-off member shown in FIG. 21;

FIG. 28 is a rear elevation view of one embodiment of the auxiliary braking apparatus in which the stand-off member is adjusted to a maximum height;

FIG. 29 is a rear elevation view of one embodiment of the auxiliary braking apparatus in which the stand-off member is adjusted to a lowest height;

FIG. 30 is a perspective view depicting one embodiment of the gripping member of the present invention being attached to the brake pedal of the towed vehicle;

FIG. 31 is a perspective view showing the improved pressure vessel/reservoir mounted within the lower shell of the auxiliary braking apparatus;

FIG. 32 is a vertical section taken along line 31-31 of FIG. 31 illustrating internal details of the pressure vessel including the manner in which an overmolded section attaches to the halves of the pressure vessel, as well as how an internal seal is used to ensure that the vessel is leak proof; and

FIG. 33 is a schematic representation of the braking apparatus.

### DETAILED DESCRIPTION

While this invention is susceptible of embodiments in many different forms, there are, as shown in the drawings and will herein be described in detail, a preferred embodiment of the invention. The reader is to understand that the present disclosure is to be considered as an exemplification of the principles of the invention and is not intended to limit the broad aspects of the invention to the embodiment illustrated.

The present invention recognizes the limited nature of conventional auxiliary braking systems for towed vehicles and offers a solution to the problem of providing a more accurate braking system that can also be more easily removed and assembled with less components. Thus, the present invention presents an improvement to traditional supplemental braking systems for towed vehicles.

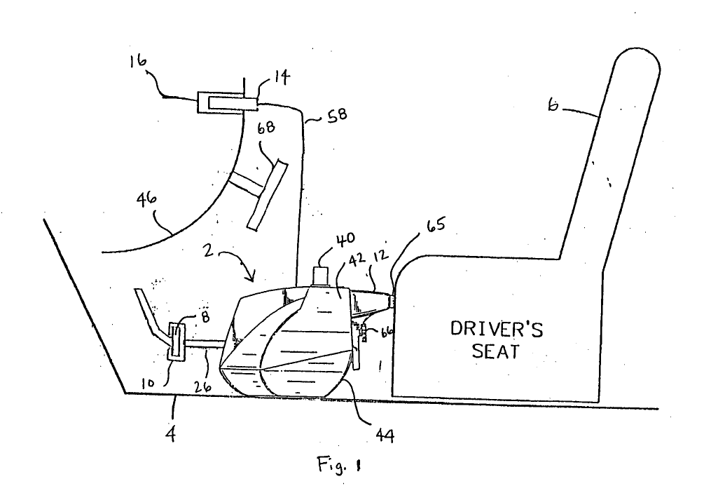

Referring now to the drawings, FIG. 1 depicts a side perspective view of the auxiliary braking apparatus of the present invention in use with a towed vehicle. Since the auxiliary braking apparatus 2 is a non-invasive, stand-alone device (i.e., there is no need to tap into the existing brake lines of the towed vehicle), the auxiliary braking device 2 is easily removed when the operator wishes to drive the towed vehicle. As shown in FIG. 1, the auxiliary braking apparatus 2 is positioned on a floorboard 4 of the towed vehicle between a driver's seat 6 and a brake pedal 8. A gripping member 10, e.g., a clevis, is manually expanded to an open position and then slipped over the brake pedal 8. The driver's seat 6 is adjusted forward until the driver's seat 6 contacts a stand-off member 12 of the auxiliary braking apparatus 2, which can be adjusted to accommodate varying heights of driver's seats 6. The auxiliary braking apparatus 2 is further comprised of a corded plug 14 which is inserted into a 12 volt lighter receptacle 16. The auxiliary braking apparatus 2 is now ready for adjustment and operation, as will be described in further detail below.

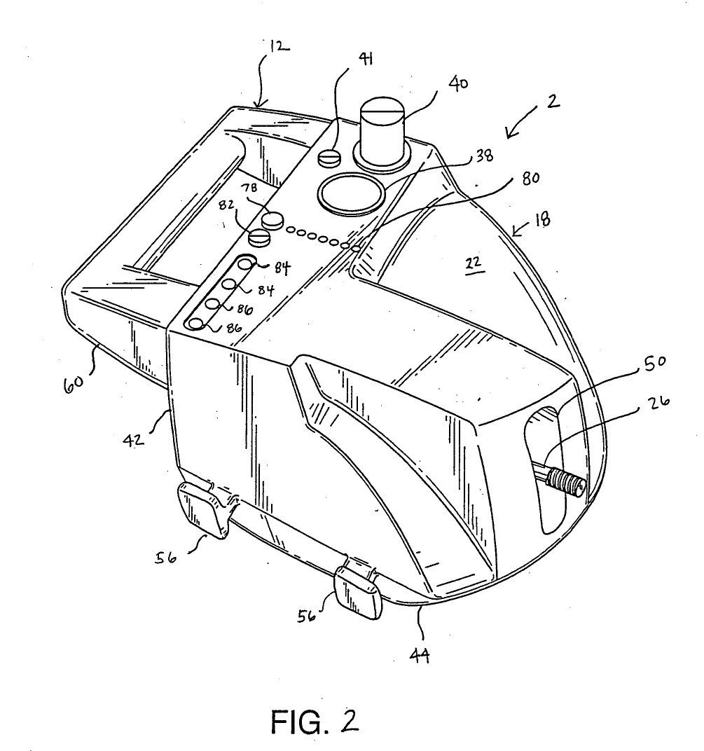

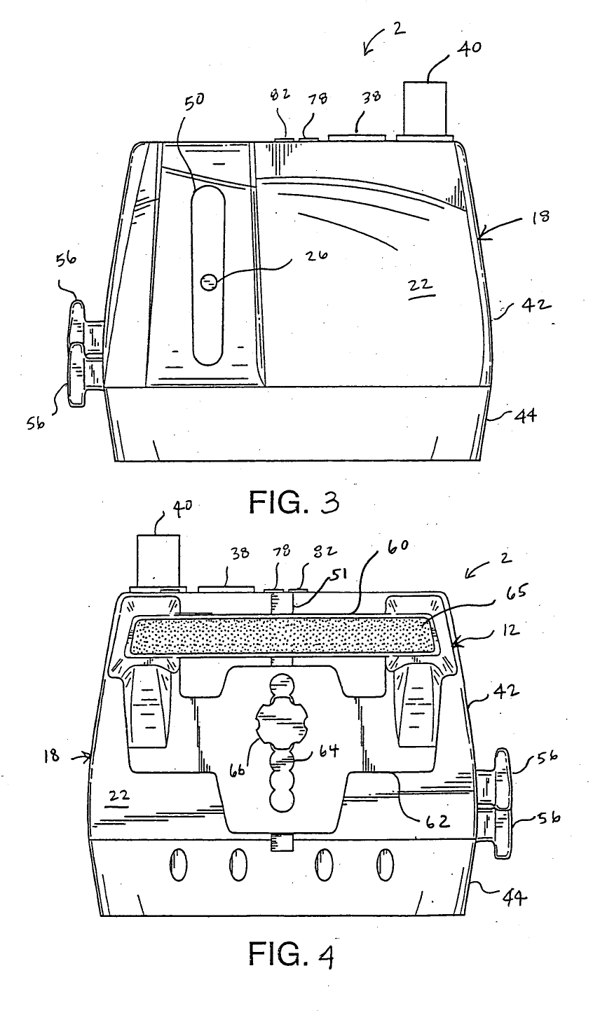

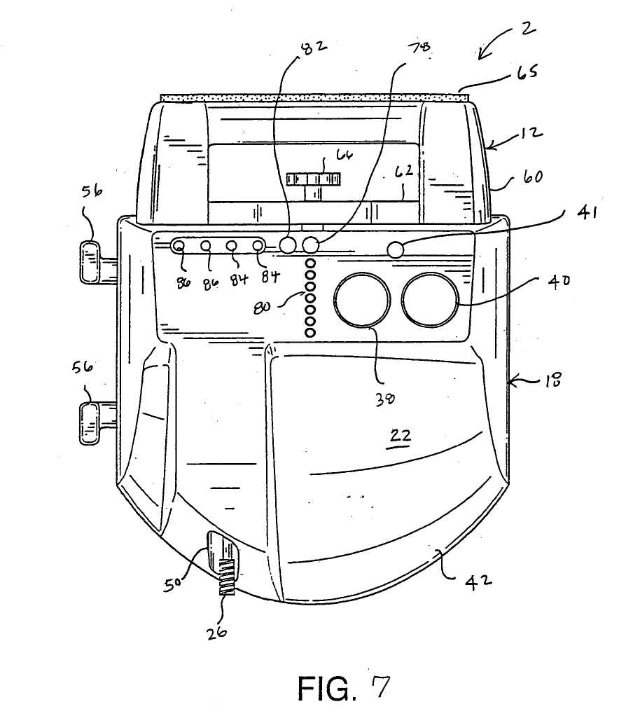

FIGS. 2-8 depict various perspective and elevation views of one embodiment of the auxiliary braking apparatus. In general, the auxiliary braking apparatus 2 is comprised of a housing 18 having an inner surface 20 (shown in FIG. 9) and an outer surface 22 that is interconnected to the stand-off member 12. As shown in FIG. 9, which depicts a basic schematic representation of the embodiment shown in FIGS. 2-8, the housing 18 encases a cylinder 24 with an actuator arm 26 that communicates with and ultimately depresses the brake pedal 8 (not shown) of the towed vehicle by a gripping member 10. A support plate 29a is connected to the inner surface of the housing 18 to provide additional support for the actuator arm 26. A first clevis 29b is interconnected to the support plate 29a and the actuator arm 26 to allow the actuator arm 26 to rotate upward to accommodate varying brake pedal 8 heights. A compressor 30, which is also encased in the housing 18, maintains a controlled pressure on the fluid within a reservoir 32. A solid state inertia device 33 senses changes in inertia attributable to the braking of the towing vehicle and communicates such changes to a circuit board 34. The circuit board 34 communicates with a valve 35, which controls fluid flow between the reservoir 32 and cylinder 24. A gauge 38, connected to the housing 18, displays the amount of fluid pressure available in the reservoir 32. A regulator 40, which is also connected to the housing 18, allows the operator to manually adjust the amount of fluid pressure that travels from the reservoir 32 to the cylinder 24. A drain valve 41, seated on the housing 18, is connected in parallel with the reservoir 32 to manually adjust the amount of fluid pressure desired for operating the auxiliary braking apparatus 2. As described below or as is otherwise within the skill of those in the art, additional displays, ports, valves, buttons, gauges, or other indicator elements can be used alone or in combination with those devices previously described and still be within the spirit and scope of the present invention.

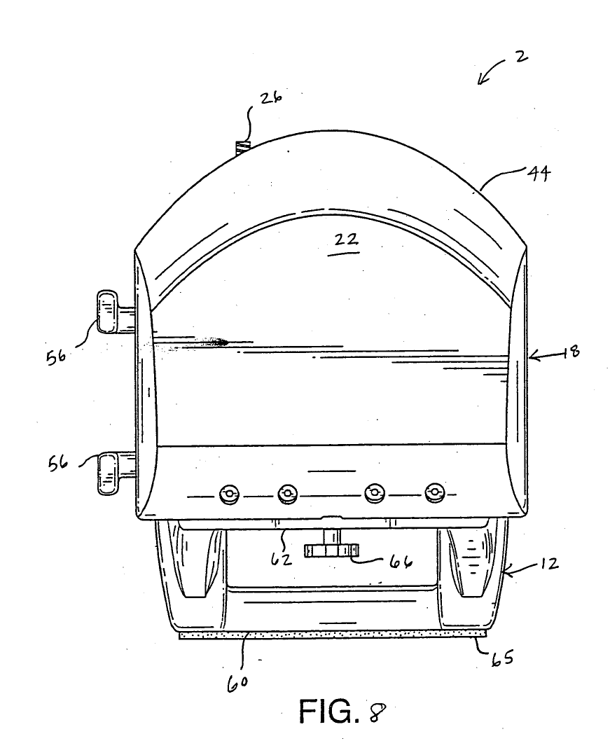

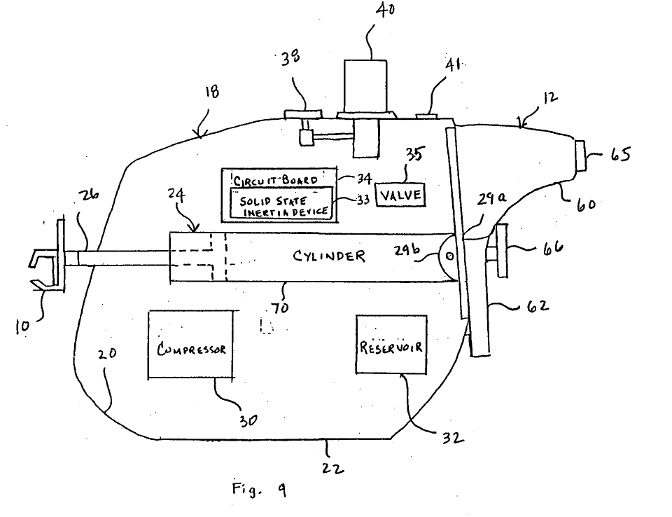

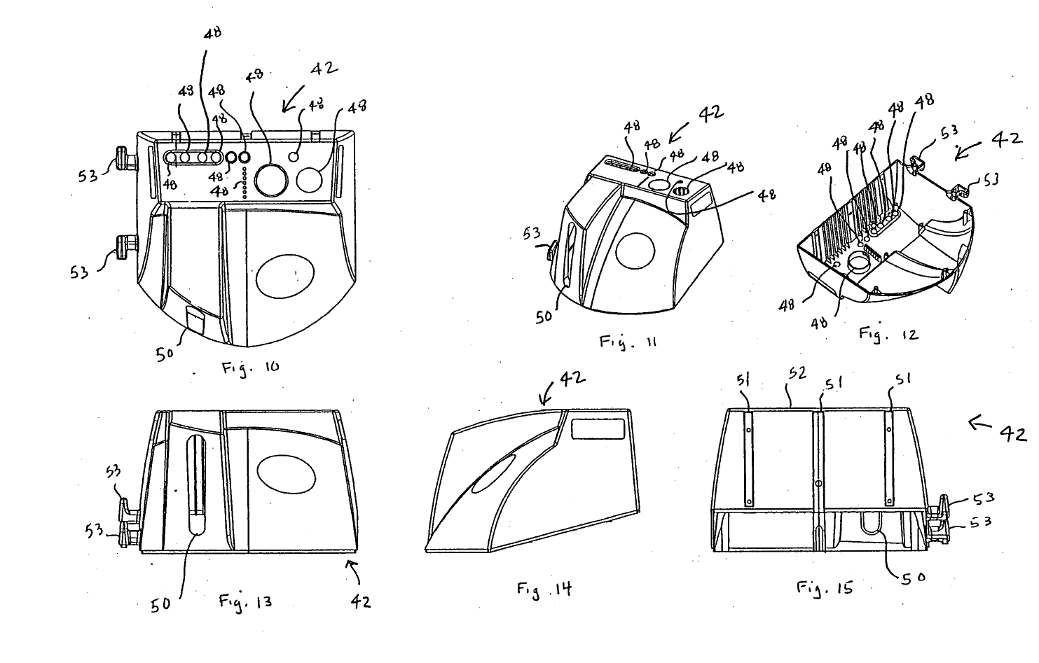

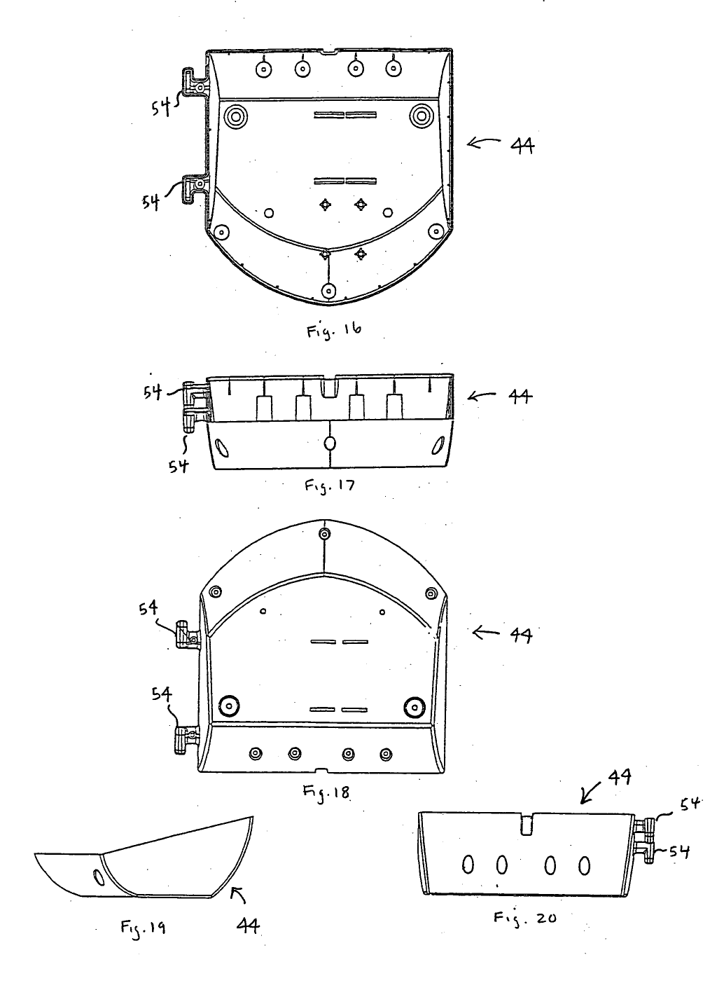

Turning now to FIGS. 10-20, the housing 18 is further comprised of a upper shell 42 (FIGS. 10-15) and a lower shell 44 (FIGS. 16-20). The two-piece construction facilitates assembly and servicing of the auxiliary braking apparatus 2. The housing 18, however, can also be made of a one-piece construction if so desired. The upper shell 42 and lower shell 44 can be made in a variety of shapes and materials, all of which are also within the spirit and scope of the present invention. The upper shell 42 is made out of an impact-resistant, lightweight material, such as Acrylonitrile Butadiene Styrene (“ABS”) plastic or a material having similar characteristics, in order to prolong the life of the auxiliary braking apparatus 2 by minimizing any unexpected impact (e.g., accidental dropping or bumping of the apparatus 2) during installation and removal. In addition, using a material like ABS reduces the overall weight of the auxiliary braking apparatus 2, thereby facilitating the removal and installation of the auxiliary braking apparatus 2, which is especially desirable for elderly operators.

As shown in FIGS. 1 and 2, The upper shell 42 is configured with a forward sloping profile so that the auxiliary braking apparatus 2 can be positioned against the brake pedals 8 of a variety of towed vehicles without the concern that the auxiliary braking apparatus 2 will be obstructed by dashboards 46 or components emanating therefrom. Thus, the sloping profile of the upper shell 42 offers an advantage over other known supplemental braking devices, which are more box-like in design, and hence, more limited to only those vehicles with sufficient clearance between their respective floorboard and dashboards, 4, 46. The upper shell 42 is further comprised of a plurality of apertures 48 that are used to position various gauges, plugs, buttons, and knobs, as further discussed below. In addition, the upper shell 42 includes an actuator arm aperture 50, which allows the actuator arm 26 to be moved up or down to accommodate varying heights of brake pedals 8, and at least one channel 51 that is vertically positioned on a rear side 52 of the upper shell 42, which allows the stand-off member 12 to be adjusted to abut against a variety of sizes of driver's seats 6. The upper shell 42 is further comprised of two upper profiles of cleats 53 (see FIGS. 2, 10, 12, 13, and 15), which are interconnected to or molded as part of the upper shell 42. Similarly, lower profiles of cleats 54 are molded or interconnected at corresponding positions along the lower shell 44 so that when the upper shell 42 and lower shell 44 are interconnected, L-shaped cleats 56 (see FIG. 2) are formed, which can be used to wrap a cord 58 (see FIG. 1) during non-use of the auxiliary braking apparatus 2. As one ordinarily skilled in the art can appreciate, any number of cleats 56 can interconnected or integrated into the housing 18 or none need be used at all. Moreover, the cleats 56 can be made in a variety of shapes and sizes.

Referring back to FIGS. 1-3, the lower shell 44 acts as a base for the auxiliary braking apparatus 2. In addition, the lower shell 44 aids in encasing the reservoir 32 and compressor 30 (both shown in FIG. 9). Similar to the upper shell 42, the lower shell 44 has a upward sloping profile in order to avoid any protrusions emanating from the floorboard 4 of the towed vehicle and thus, making the auxiliary braking apparatus 2 universally adaptable to various makes and models of towed vehicles.

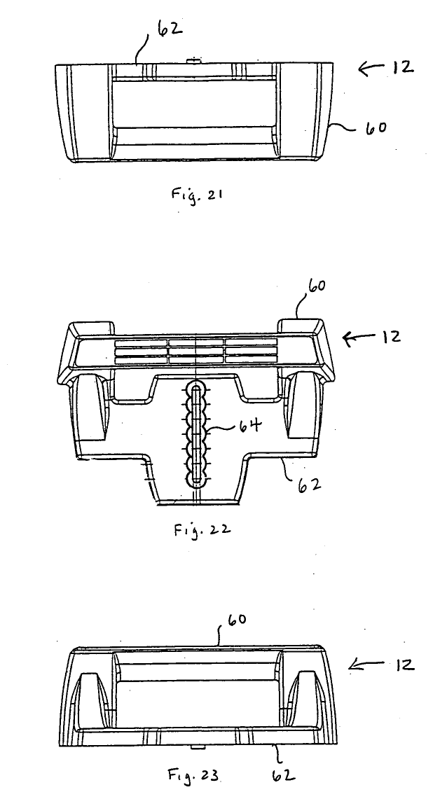

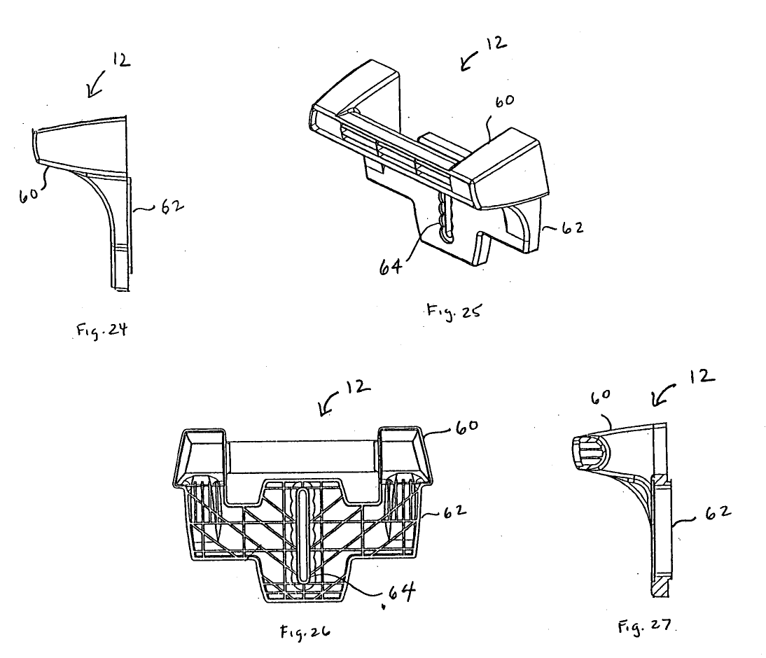

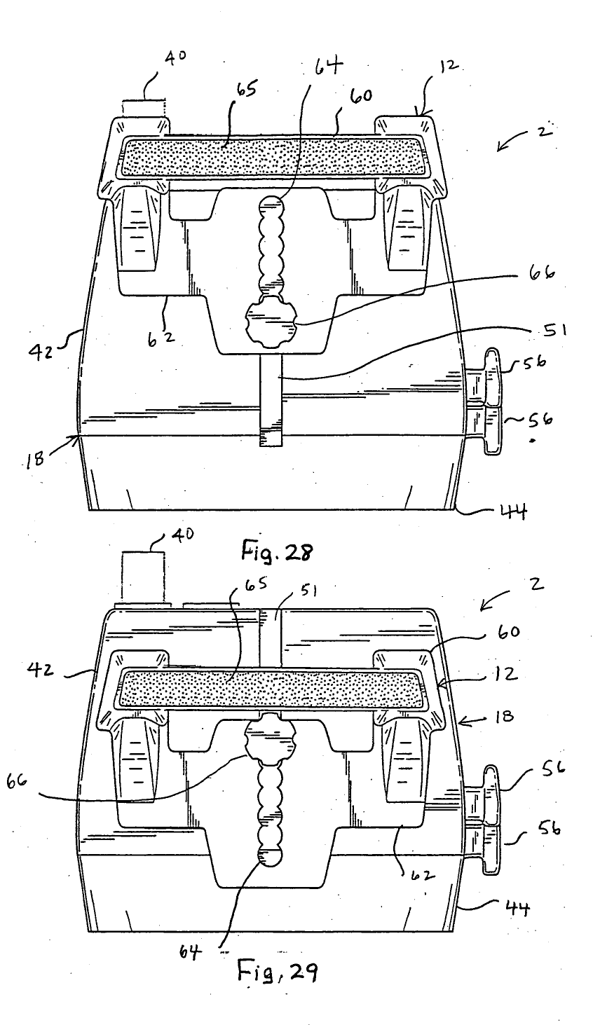

In order to securely position the auxiliary braking apparatus 2 on the floorboard 4, the auxiliary braking apparatus 2 further includes a stand-off member 12 that can also be used as a handle to carry the auxiliary braking apparatus 2. Unlike other known, supplemental braking systems, the present invention combines the need for a carrying handle with a means for securely positioning the auxiliary braking apparatus 2. As a result, less manufacturing materials are used and the overall weight of the unit is minimized, which facilitates installation and removal. As shown in FIGS. 21-27, the stand-off member 12 is comprised of a carrying handle 60 interconnected to a backplate 62 with a vertically-oriented adjustment aperture 64. In order to ensure that the stand-off member 12 does not slide off of a front surface of the driver's seat 6, a grip pad 65 (shown in FIGS. 1, 28, and 29) is interconnected to the carrying handle 60. Although preferably made out of rubber, the grip pad 65 can also be made out of other materials offering similar tactile qualities. The stand-off member 12 is adjustably interconnected to the rear side 52 of the upper shell 42 by screwing a threaded knob 66 through the adjustment aperture 64 and into the channel 51 of the upper shell 42. See FIG. 28. After the gripping member 10 has been attached to the brake pedal 8 and the driver's seat 6 has been moved toward the auxiliary braking apparatus 2, the stand-off member 12 can be adjusted away from the floorboard 4 or toward a steering wheel 68 of the towed vehicle so that the grip pad 65 is securely positioned against the driver's seat 6. In order to adjust the stand-off member 12 to the appropriate height of the driver's seat 6, the operator slides the backplate 62 along the channel 51 of the upper shell 42 and then secures the backplate 62 against the upper shell 42 by tightening the threaded knob 66. Using this method, the operator can adjust the height of the stand-off member 12 to a plurality of heights, thereby accommodating a variety of vehicles with different models and sizes of driver's seats 6. See FIGS. 28 and 29. As one ordinarily skilled in the art can appreciate, the stand-off member 12 can be adjustably connected to the upper shell 42 of the auxiliary braking apparatus 2 in a variety of ways, all of which are within the spirit and scope of the present invention.

In order to depress the brake pedal 8 of, and ultimately slow, the towed vehicle, the auxiliary braking apparatus 2 is reliant upon the transmittal of pressurized fluid. As one ordinarily skilled in the art can appreciate, the fluid can take many forms, such as air, gas, hydraulic fluid, or steam, and still be within the spirit and scope of the present invention. The pressurized fluid is released into the cylinder 24 in order to depress the brake pedal 8 of the towed vehicle. As shown in FIG. 9, the cylinder 24 is further comprised of the actuator arm 26 in slidable communication with a casing 70. While the casing 70 has a substantially circular cross-sectional shape, the casing 70 can also be made with a variety of other cross-sectional shapes, such as octagonal, square, rectangular, triangular, etc., and still be within the scope of the present invention. The actuator arm 26 is preferably manufactured in a conventional piston/rod configuration and functions in two positions: (1) a first position of rest in which the actuator arm 26 remains in a retracted position within the casing 70 and (2) a second position of use in which the actuator arm 26 is extended away from the casing 70 in order to depress the brake pedal 8 of the towed vehicle. The cylinder 24 is not limited by the transmittal of any particular type of pressurized fluid. Rather, the cylinder 24 can be hydraulically, pneumatically, or electrically driven and still be within the scope of the present invention.

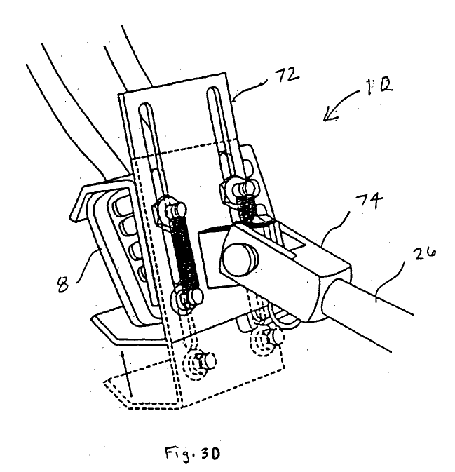

Referring back to FIG. 1, the actuator arm 26 communicates with the brake pedal 8 via a gripping member 10. The gripping member 10 is preferably an adjustable brake pedal fastener 72, which is interconnected to the actuator arm 26 via a second clevis 74. See FIG. 30. The adjustable nature of the brake pedal fastener 72 allows the operator to quickly and easily disengage the auxiliary braking apparatus 2 from the brake pedal 8 and offers use with a greater variety of vehicles having differing sizes of brake pedals 8. The means by which the actuator arm 24 grasps the brake pedal 8 is not the essence of the present invention. Thus, any means of interconnecting the actuator arm 26 to the brake pedal 8, whether adjustable in nature or not (e.g., a clamp/wing nut configuration), are within the scope of the present invention.

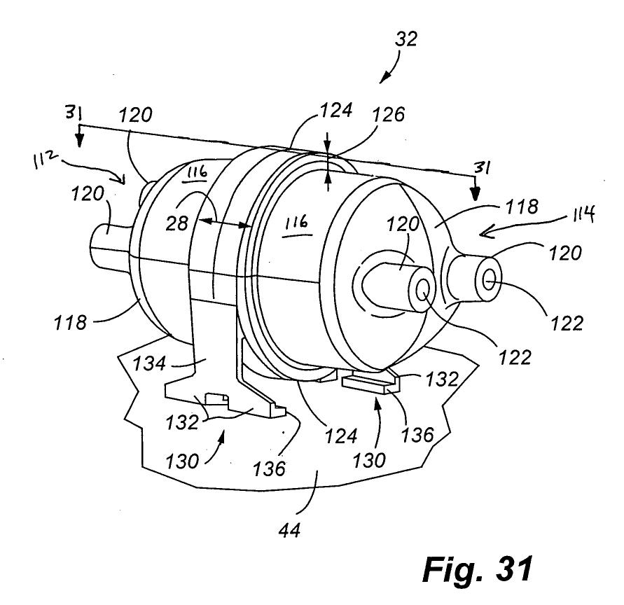

Referring now to FIG. 31, the reservoir 32 is shown as being mounted internally within the lower shell of the housing. As further discussed below, the reservoir 32 is placed in fluid communication with the cylinder 24, and the purpose of the reservoir 32 is to store pressurized fluid that is released upon command from the operator in order to drive the actuator arm 26. Structurally, the reservoir 32 may be defined by respective first and second half sections 112 and 114. The first and second half sections are joined by an overmolded section 124. Each half section includes sidewalls 116 and end portions or sections 118. A plurality of ports 120 may be formed on each of the end sections 118. As shown, there are two ports 120 formed on each end section 118. However, it shall be understood that a fewer or greater number of ports may be formed depending upon the manner in which it is desired to pipe the braking apparatus. Each of the ports 120 includes an orifice/opening 122 which communicates with the interior of the reservoir 32.

The overmolded section 124 may be defined as having a thickness 126 which is measured as the radial distance from the sidewalls 116 to the exterior edge of the overmolded section. A width 128 of the overmolded section 124 may be defined as the longitudinal extension of the overmolded section which overlaps the half sections 112 and 114. One or more features may be integrally molded with either the overmolded section 124, and/or with the molded half sections 112, 114. As shown in FIG. 31, a pair of feet 130 are integrally molded with the overmolded section 124. The feet 130 each include a base portion 132, an extension 134 which is connected to the exterior edge or side of the overmolded section 124, and a perpendicularly extending flange 136. The flanges 136 are shown as having flat lower surfaces which attach directly to the lower interior surface of the lower shell 44. Accordingly, the reservoir 32 may be mounted directly to the interior of the housing without requiring use of additional hardware.

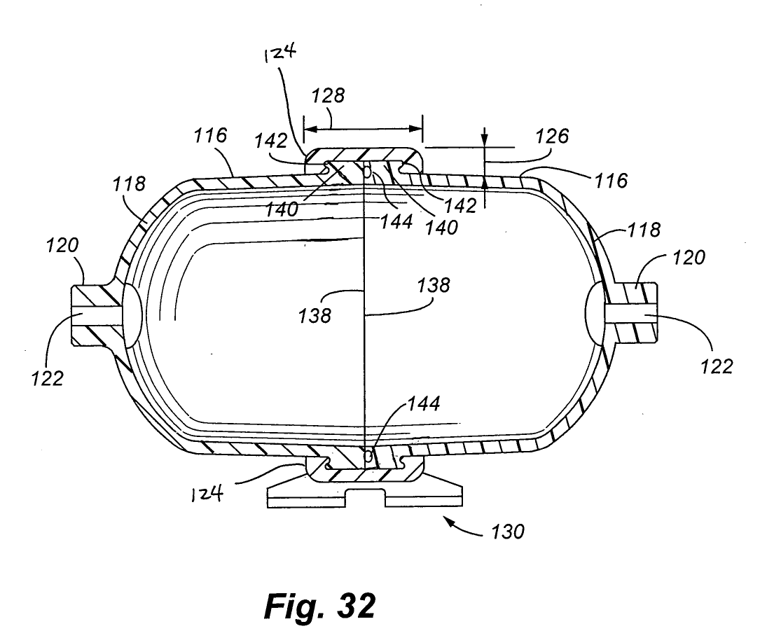

FIG. 32 illustrates interior details of the reservoir 32. The first and second half sections each terminate in end or abutting surfaces 138 which become fused to one another in the molding process as discussed further below. The first and second half sections each also include an annular flange 140 and an integral protrusion 142 which extend circumferentially around the half sections.

In a first molding step, the first and second half sections are formed in injection molding from a first set of molds. Preferably, the half sections are made from a glass filled nylon material. In testing, it was found that glass filled nylon producedhalf sections which had sufficient strength to withstand the fluid pressures which were experienced within the braking apparatus. After forming the half sections in the first injection molding step, both the first and second half sections are placed within a second mold which allows formation of the overmolded section 124 in a second injection molding step. In the second molding step, the glass filled nylon is injected into the second mold to thereby form the overmolded section over and around the first and second half sections as illustrated in FIGS. 31 and 32.

In the first molding step, an annular channel may be formed in one of the half sections which allows an optional O-ring seal 144 to be emplaced in the second molding step. The O-ring is sized to allow an exposed side or edge thereof to extend outwardly beyond the corresponding abutting surface 138. The O-ring is compressed between the first and second half sections in the second molding step to provide a seal between the half sections. Alternatively, the O-ring could be placed in a channel formed in the cavity of the first mold used to make one of the half sections. The O-ring would therefore become fused to an abutting surface 138 in the first molding step. One edge of the O-ring would remain exposed for later compression against the other half section in the second molding step.

Due to the heat and pressure within the mold in the second molding step, the abutting surfaces of the first and second half sections become fused to one another, and the overmolded section itself becomes fused over the annular flanges 140 and adjacent portions of the sidewalls 116. In order to provide greater reliability in terms of sealing the reservoir, the O-ring 144 can be used. However, depending upon the fluid pressures experienced within the braking apparatus, the fusing of the materials in the second molding step alone may be adequate to create a sealed reservoir.

In the second molding step, the feet 130 are also formed by the glass filled nylon that fills the cavity of the second mold. It shall be understood that alternatively, the feet 130 can be formed to protrude from the half sections, or other structures may be formed in the second molding step enabling the reservoir 32 to be directly mounted to the housing of the braking apparatus.

By creating the reservoir 32 from a two stage molding process, the reservoir 32 is a much simpler yet reliable design. Installation of the reservoir is also made easier because of the integrally molded attaching features in the form of the feet 130. Glass filled nylon is an advantageous material to use in injection molding and is able to withstand a wide range of fluid pressures which may be experienced within the braking apparatus.

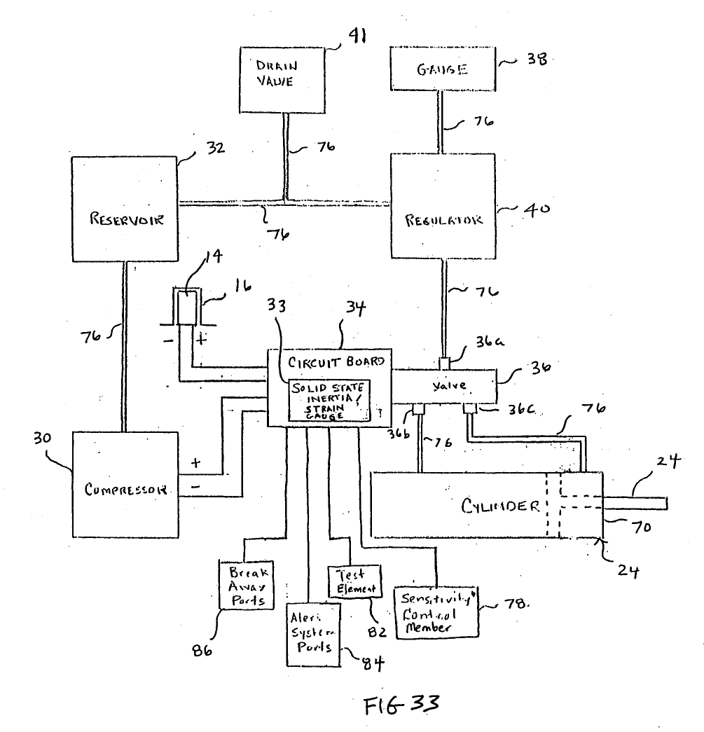

Referring now to FIG. 33, the reservoir 32 is in fluid communication with the cylinder 24. The reservoir 32 stores the pressurized fluid that will ultimately be released upon command from the operator in order to drive the actuator arm 26 and depress the brake pedal 8 of the towed vehicle. In FIG. 33, electrical connections of the present invention are represented by single lines while fluid connections are depicted using double lines. As one ordinarily skilled in the art can appreciate, the reservoir 32 can be made in any shape and size. Preferably, as mentioned above, the reservoir 32 is mounted within the housing 18 so that the reservoir 32 is protected from accidental damage. However, the reservoir 32 may also be positioned outside of the housing 18 as well.

Also shown in FIG. 33, is the compressor 30, which is used to pressurize the fluid (e.g., air, hydraulic fluid) within the reservoir 32. Again, the compressor 30 can be hydraulic or pneumatic and still be within the scope of the present invention. The size of the compressor 30 is dependent on the type of pressurized fluid and the range of vehicles for which the auxiliary braking device 2 is manufactured to tow. A 12 volt, 10.5 amp compressor 30 is used. Alternatively, other compressors 30 of various sizes could be substituted depending on the needs of the manufacturer of the auxiliary braking device 2. As further shown in FIG. 33, the compressor 30 receives its power supply from the 12 volt lighter receptacle as communicated through the circuit board 34.

Due to the portable nature of the present invention, it is preferable that the auxiliary braking apparatus 2 be powered by the corded plug 14, as shown in FIG. 1. However, as one ordinarily skilled in the art can appreciate, alternative means of providing an electrical power supply to the auxiliary braking apparatus 2 are also within the scope of the present invention. For example, a conventional, rechargeable or non-rechargeable battery could be connected to the circuit board 34. In addition, the auxiliary braking apparatus 2 could be hard wired into the electrical system of the towed vehicle.

In order to accommodate a variety of sizes of towed vehicles it is necessary that the amount of force applied by the auxiliary braking apparatus 2 to the brake pedal 8 of the towed vehicle be capable of being varied. To this end, the regulator 40 is interposed between the reservoir 32 and the cylinder 24 so that varying amounts of pressurized fluid can be released from the reservoir 32 to the cylinder 24, and hence the actuator arm 26. See FIG. 31. Varying types of regulators 40 (e.g., air, hydraulic, gas, liquid, steam, etc.) can be used and still be within the scope of the present invention. For example, the regulator 40 is an adjustable filter regulator, which filters and disperses into the air condensation generated as a result of the compressed fluid. Similarly, the regulator 40 can be constructed out of a variety of materials, such as aluminum, brass, bronze, steel, plastic, etc. The regulator 40 is mounted on the outer surface of the housing 22 so that it is easily accessed by the operator. See FIG. 2. The gauge 38 is interconnected to the regulator 40 so that the operator can adjust the amount of desired pressure (e.g., psi) in accordance with the weight of the towed vehicle. Like the regulator 40, various types of gauges 38 can be used (e.g., digital, conventional needle, etc.). Of course, the gauge 38 can be omitted entirely from the auxiliary braking apparatus 2 as well.

In order to transmit pressurized fluid to the cylinder 24 so that the actuator arm 26 extends or retracts, the cylinder 24 and the regulator 40 communicate through the valve 36. See FIG. 33. The valve 36, in turn, is in electrical communication with and controlled by the circuit board 34. The valve 36 is may be conventional three port valve (see FIG. 33), which is further comprised of an input port 36a, an extension port 36b, and a retraction port 36c. Depending on the signal received from the circuit board 34, either the extension port 36b or retraction port 36c is opened from its idle, closed position. When the operator needs the actuator arm 26 to extend (i.e., to depress the brake pedal 8 of the towed vehicle), the extension port 36b is opened so that pressurized fluid flows from the input port 36a through the extension port 36b, which drives the actuator arm 26. Conversely, when the brake pedal 8 needs to be released, the retraction port 36c is opened so that pressurized fluid is transmitted to an opposite surface of the actuator arm 26, thereby driving and retracting the actuator arm 26 from the brake pedal 8. As one ordinarily skilled in the art can appreciate, various means of driving and retracting the actuator arm 26 can be used (e.g., various types of valves) and still be within the scope of the present invention. Thus, the use of a three port valve 36 is presented as merely one example of controlling the flow of the pressurized fluid from the reservoir 32 to the actuator arm 26.

Still referring to FIG. 33, if the operator wishes to release pressurized fluid from the reservoir 32, the drain valve 41 can be connected in parallel to the reservoir 32. The drain valve 41 may be a conventional push button release valve. Other types of conventional release valves are also within the scope of the invention.

Piping 76 used to transmit the pressurized fluid can be made out of metal, plastic, or a composite material depending on the type of pressurized fluid used. The piping 76 is preferably of sufficient thickness to accommodate a variety of pressures depending on the size of the towed vehicles. These pressures will normally be in the range of 20 to 100 psi, but can be higher if the weight of the towed vehicle is increased.

The triggering mechanism of the auxiliary braking apparatus will now be discussed. As noted above, the auxiliary braking apparatus 2 is activated based on changes in inertia generated by the slowing of the towing vehicle. Conventional supplemental braking systems using mechanical inertia-sensing devices, such as pendulums, are particularly prone to erratic behavior due to gravitational effects. The present invention substantially eliminates this problem by replacing the conventional pendulum with a solid state inertia device 33. The solid state inertia device 33 may be a semi-conductor chip coupled with a strain gauge, both of which are in electrical communication with the circuit board 34. As the towed vehicle is braked, the strain gauge of the solid state inertia device 33 (i.e., accelerometer) senses the change in inertia experienced by the towed vehicle. A corresponding increase in voltage is transmitted to the circuit board 34 and stored in a capacitor or other similar storage device known in the art. During a pre-selected interval (e.g., every second), the voltage is compared against a threshold chosen by the operator. See below for discussion of threshold selection. If the voltage exceeds the threshold (i.e., representing a rapid change in inertia due to braking), an electrical signal is sent to the valve 36 to open the extension port 36b, thereby extending the actuator arm 26 and braking the towed vehicle. A conventional amplifier (not shown) can be interposed between the capacitor (i.e., storage device) and the valve 36 in order to amplify the electrical signal. If the voltage does not exceed the threshold, but is rather attributable to a change in gravity (e.g., when the towed vehicle is ascending a hill), the circuit board 34 zeroes out the voltage stored in the capacitor or similarly configured storage device. Thus, gravitational effects are substantially eliminated from the auxiliary braking device 2.

As one ordinarily skilled in the art can appreciate, any conventional circuit board 34 can be used to control the valve 36. Similarly, additional hardware, firmware, and/or software can be used alone, or in combination, with the circuit board 34 and still be within the spirit and scope of the present invention.

While the present invention has been described for“on/off” applications (i.e., the brake pedal is either depressed or remains in its normal, non-depressed position), it is also envisioned that the auxiliary braking apparatus 2 can be adapted to apply proportional braking force to the towed vehicle. In this embodiment, software is coupled with existing hardware components to release pressurized fluid to the actuator arm 26, and hence to the brake pedal 8 of the towed vehicle in a manner that is proportional to the amount of braking force applied to the towing vehicle.

In order to better accommodate a variety of operator's braking styles, the auxiliary braking apparatus 2 is further comprised of a sensitivity control member 78. See FIGS. 2 and 33. Unlike conventional supplemental braking systems, which use pendulums as activation switches, the present invention offers a broader range of sensitivity settings. As noted above, pendulum-oriented systems are limited by the length of the pendulum arm as to the extent of sensitivity settings. The present invention, however, is not limited in a similar manner and hence, offers lower sensitivity settings. The sensitivity control member 70 varies the voltage threshold used to activate the actuator arm 26. Further, the sensitivity control member 78 may be a button switch that communicates with the circuit board 34, but can also be any type of switch known within the art. A display 80 can also be interconnected to the housing 18 and positioned in electrical communication with the sensitivity control member 78 so that the operator can visually confirm adjustments made to sensitivity settings for the auxiliary braking apparatus 2. The display 80 may be a plurality of LEDs. See FIG. 2. By depressing the sensitivity control member 78, the voltage threshold can be raised or lowered, as depicted by the number of LEDs that are illuminated.

The present invention also provides the operator with an opportunity to test the auxiliary braking apparatus 2 before the operator drives away. A test element 82 is interconnected and provides an electrical signal to the circuit board 34, which activates the valve 36 in a manner similar to the solid state inertia device 33. See FIGS. 2 and 33. While preferably a button switch, the test element 82 can be any type of conventional switch.

While the present invention has been developed to be an autonomous device, which automatically brakes the towed vehicle without any operator interaction, the auxiliary braking apparatus 2 is further comprised of a conventional transmitter that is used by the operator and communicates with a conventional receiver in electrical communication with the circuit board 34. When braking of the towed vehicle is desired, the operator merely depresses the transmitter, which communicates in a wireless or corded manner with the receiver, thereby activating the valve 36 in a manner similar to that described above for the solid state inertia device 33. The receiver can be fixedly interconnected to the circuit board 34 or can communicate electronically with the circuit board 34 with a conventional port that is positioned on the housing 18.

The operation of the auxiliary braking apparatus 2 will now be described. Once the auxiliary braking apparatus 2 has been installed in the towed vehicle (as described above), the operator adjusts the regulator 40 to set the appropriate amount of pressure to be released to the cylinder 24. The requisite amount of pressure is functionally related to the weight of the towed vehicle and, for example, can be adjusted between 0 and 160 psi. The operator can also adjust the sensitivity of the auxiliary braking apparatus 2 by depressing the sensitivity control member 78 until the desired sensitivity is achieved. The system is now ready to be used by the operator. Upon braking of the towing vehicle by the operator, an increase in inertia is sensed by the solid state inertia device 33, which is relayed to the circuit board 34. The circuit board 34 sends an electrical signal to the valve 36, which causes the actuator arm 26 to extend and depress the brake pedal 8 of the towed vehicle, thereby removing the weight of the towed vehicle off of the towing vehicle. Once the operator releases the brakes of the towing vehicle, the actuator arm 26 is retracted in the manner described above and the brake pedal of the towed vehicle allowed to return to its original position of non-use.

In order to alert the operator as to when the auxiliary braking apparatus 2 has been activated, the present invention can be further comprised of a corded or wireless transmitter that is removably or permanently interconnected to the auxiliary braking apparatus 2 via alert system ports 84, which are in electrical communication with the circuit board 34, or other conventional connection means. The alert system ports 84 may be a pair of female plugs. See FIGS. 2 and 33. Once the auxiliary braking apparatus 2 is activated, the transmitter communicates with a receiver that is kept in the towing vehicle. Preferably, the receiver is further comprised of indicator means, such as a light or audio device, so that the operator is visually or audibly alerted to the activation of the auxiliary braking apparatus 2. The indicator means may be an LED or any other suitable visual indicator. Alternatively, the indicator means could be an audio speaker.

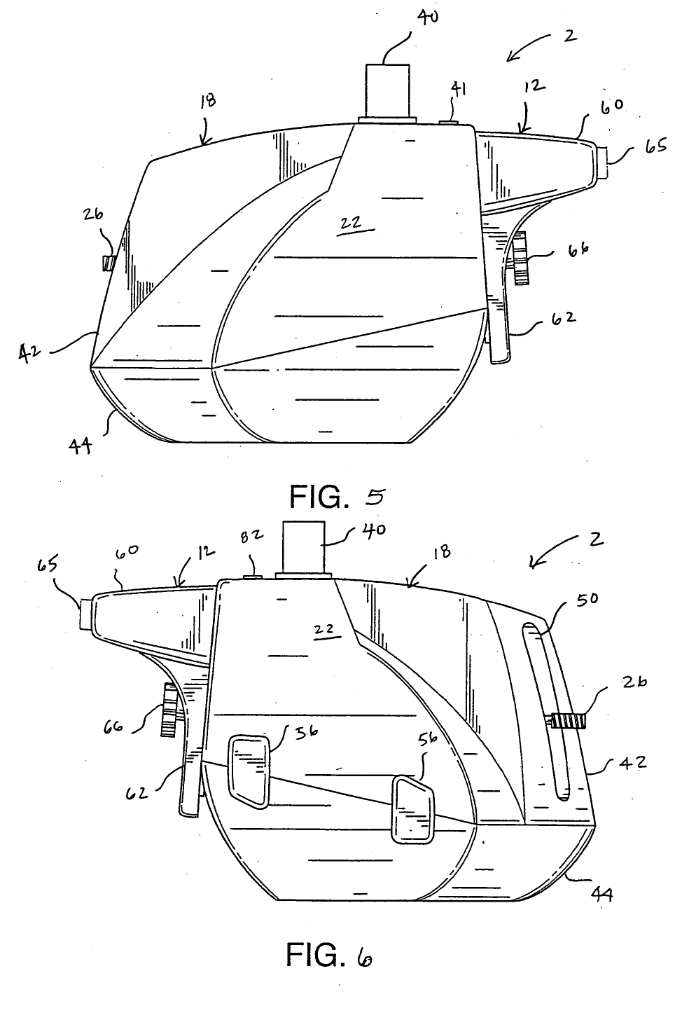

Still further, the present invention also includes break away ports 86, which are used to apply the brake pedal 8 of the towed vehicle if the towed vehicle is inadvertently separated from the towing vehicle while in transit. The break away ports 86 can be adapted for use with a variety of separation detection mechanisms readily known in the art. For example, the break away ports 86 are in electrical communication with the circuit board 34 and are mounted on the housing 18 for easy access. The break away ports 86 are used to transmit an electrical signal to the valve 36 so that the extension port 36b is opened. This is accomplished by mounting a conventional junction box on a front side of the towed vehicle. Electrical cables interconnect the break away ports 86 to the junction box. The junction box is further comprised of a female plug that houses a pair of spring-biased electrodes. See, e.g., U.S. Pat. No. 6,126,246 to Decker, Sr. et al., FIG. 5. A non-conducting male banana terminal is inserted into the female plug. The non-conducting male banana terminal is connected to a cable that is anchored to the towing vehicle at one end. In this configuration the break away ports 86 are in an open circuit. Upon accidental separation from the towing vehicle, the male banana terminal is pulled from the female plug by the cable that remains attached to the towing vehicle. The spring-biased electrodes make contact, an electrical circuit is completed, and an electrical signal is sent via the electrical cables to the break away ports 86, which communicate with the circuit board 34 and ultimately the valve 36. Consequently, the brake pedal 8 of the towed vehicle is depressed and the towed vehicle comes to a stop.

While an effort has been made to describe some alternatives to the preferred embodiment, other alternatives will regularly come to mind to those skilled in the art. Therefore, it should be understood that the invention may be embodied in other specific forms without the parting from the spirit or central characteristic thereof. The present examples and embodiments, therefor, are to be considered in all aspects as illustrative and not restrictive, and the invention is not intended to be limited to the details given herein.

What is claimed:

1. An apparatus for braking a towed vehicle comprising:
a housing;
an actuator arm at least partially enclosed by said housing, said actuator arm having a first rest position and a second use position;
a solid state inertia device communicating with the actuator arm;
a first member in communication with the actuator arm for contacting a brake pedal of the towed vehicle;
a power supply for providing power to actuate the actuator arm;
a pressure vessel for storing compressed fluid used in the braking apparatus to extend and retract said actuator arm, said pressure vessel being constructed from an injection molding process; and
wherein the actuator arm is retracted in the first rest position, and the actuator arm is extended in the second use position causing the first member to depress a brake pedal of the towed vehicle in response to a signal generated from the solid state inertia device.

2. An apparatus, as claimed in claim 1, wherein:
said pressure vessel further includes at least one attaching member integrally molded with said pressure vessel thereby allowing said pressure vessel to be mounted directly to said braking apparatus.

3. An apparatus, as claimed in claim 1, wherein:
said pressure vessel is constructed from a two step injection molding process.

4. An apparatus, as claimed in claim 1, wherein:
said pressure vessel further includes a first half section, a second half section, and an overmolded section placed over said first and second half sections.

5. An apparatus, as claimed in claim 4, wherein:
an abutting surface of said first section is fused to an abutting surface of said second half section during molding, and said overmolded section is fused to said first and second half sections during molding.

6. An apparatus, as claimed in claim 4, wherein:
said pressure vessel further includes a seal placed between said first and second half sections, said seal being compressed during molding thereby ensuring a leak proof seal between said first and second half sections.

7. A pressure vessel comprising:
a first half section having an abutting surface;
a second half section having an abutting surface placed in abutting relationship with said abutting surface of said first half section;
an overmolded section placed over said first and second half sections adjacent said abutting surfaces;
at least one port formed on one of said first and second half sections, said port including an orifice communicating with an interior of said pressure vessel; and
wherein said pressure vessel is formed in injection molding so that said overmolded section is fused to said first and second half sections.

8. A pressure vessel, as claimed in claim 7, wherein:
said first and second half sections each include a flange formed circumferentially around said half sections, respectively, and said flanges each having one end terminating at a corresponding abutting surface.

9. A pressure vessel, as claimed in claim 8, wherein:
each flange of said first and second half sections further includes an integral protrusion which extends in a direction away from the corresponding abutting surface.

10. A pressure vessel, as claimed in claim 8, wherein:
said overmolded section encapsulates said flanges and a portion of said first and half sections residing adjacent said abutting surfaces.

11. A pressure vessel, as claimed in claim 7, further including:
means attached to said pressure vessel enabling said pressure vessel to be directly attached to another object.

12. A pressure vessel, as claimed in claim 11, wherein:
said means for attaching includes a pair of feet integrally molded with said overmolded section.

13. A method of manufacturing a pressure vessel comprising the steps of:
providing a first mold having a cavity of a desired shape;
conducting an injection molding step to fill the cavity of the first mold with a glass filled nylon material to form a first half section;
repeating said conducting step to form a second half section;
placing said first and second half sections into a second mold, said second mold having a channel formed in a cavity of the second mold;
conducting a second injection molding step to fill the channel in the cavity of the second mold thereby forming an overmolded section to join said first and second half sections.

14. A method, as claimed in claim 13, wherein:
at least one port is formed on either said first or second half sections during said first conducting step, said port having an orifice communicating with an interior of the pressure vessel formed.

15. A method, as claimed in claim 13, further including the step of:
placing an O-ring seal between said first and second half sections prior to said second conducting step wherein said O-ring becomes compressed between said first and second half sections thereby further insuring a leak proof seal is formed between said first and second half sections.

16. A method, as claimed in claim 13, wherein:
said first and second half sections become fused to one another, and said overmolded section becomes fused to said first and second half sections during said second conducting step.

17. A method, as claimed in claim 13, wherein:
said second conducting step includes forming attachment means to at least one of said first and second half sections or to said overmolded section, said attaching means enabling said pressure vessel to be directly mounted to another object.

18. An apparatus for braking a towed vehicle comprising:
a housing;
an actuator arm at least partially enclosed by said housing, said actuator arm having a first rest position and a second use position;
means for detecting changes in inertia communicating with the actuator arm;
a first member in communication with the actuator arm for contacting a brake pedal of the towed vehicle;
a power supply for providing power to actuate the actuator arm;
means for storing compressed fluid used in the braking apparatus to extend and retract said actuator arm, said means for storing being constructed from an injection molding process; and
wherein the actuator arm is retracted in the first rest position, and the actuator arm is extended in the second use position causing the first member to depress a brake pedal of the towed vehicle in response to a signal generated from the means for detecting changes in inertia.

19. A pressure vessel comprising:
a first half section having an abutting surface;
a second half section having an abutting surface placed in abutting relationship with said abutting surface of said first half section;
means placed over said first and second half sections adjacent said abutting surfaces for securing said half sections to one another;
at least one port formed on one of said first and second half sections, said port including an orifice communicating with an interior of said pressure vessel; and
wherein said pressure vessel is formed in injection molding so that said means for securing is fused to said first and second half sections.
